(19) United States
(12) Patent Application Publication
(10) Pub. No.: US 2024/0413996 A1
(43) Pub. Date: Dec. 12, 2024

(54) ENVIRONMENTAL ATTRIBUTE ENCODING FOR AUTHORIZATION PROTOCOLS

(71) Applicant: International Business Machines Corporation, Armonk, NY (US)

(72) Inventors: Mark Duane Seaborn, Algonquin, IL (US); Patrick Aaron Tamborski, Chicago, IL (US)

(21) Appl. No.: 18/207,031

(22) Filed: Jun. 7, 2023

(51) Int. Cl. H04L 9/32; H04L 9/06

(52) U.S. Cl. CPC H04L 9/3213; H04L 9/0618

(57) ABSTRACT

A computer-implemented method, in accordance with one embodiment, includes receiving, by a token service, an Attribute Based Encryption (ABE) authorization code having environmental attributes encoded therein. At least one test is performed, by the token service, on the ABE authorization code using ABE decryption for determining whether the ABE authorization code satisfies a predefined policy that is based on the environmental attributes. In response to determining that the ABE authorization code satisfies the predefined policy, a token is issued by the token service.

### BACKGROUND

The present invention relates to authorization systems, and more specifically, this invention relates to using Attribute-Based Encryption (ABE) as a mechanism of encoding attributes required for ensuring an access policy or constraint is satisfied within a token and/or an authorization code itself.

Some types of authorization protocols allow users to authorize access to data they own on one site to third party sites for data processing use cases. Illustrative use cases range from printing photos the user stores in the cloud to running analytics against data stored in data lakes to logging into an online service. There is no limit on the number of potential data processing use cases.

ABE is a mechanism in which keys and cipher text are dependent upon attributes.

Open Authorization 2.0 (OAuth2) is an authorization protocol. For example, the standard defined by OAuth2 defines a procedure by which a website or application can access resources hosted by other web applications on behalf of a user. Moreover, while the Internet is the main platform for OAuth2, the delegated access provided by OAuth2 is also applicable to other client types such as browser-based applications, server-side web applications, native/mobile apps, connected devices, etc.

Similarly, Open ID Connect (OIDC) is an identity layer on top of OAuth2. OAuth2 deals with delegated authorization, while OIDC deals with delegated authentication, but both use similar toolsets.

### SUMMARY

A computer-implemented method, in accordance with one embodiment, includes receiving, by a token service, an Attribute Based Encryption (ABE) authorization code having environmental attributes encoded therein. At least one test is performed, by the token service, on the ABE authorization code using ABE decryption for determining whether the ABE authorization code satisfies a predefined policy that is based on the environmental attributes. In response to determining that the ABE authorization code satisfies the predefined policy, a token is issued by the token service.

A computer-implemented method, in accordance with one embodiment, includes receiving, by a computer, an ABE token having environmental attributes encoded therein. At least one test is performed, by the computer, on the ABE token using ABE decryption for determining whether the ABE token satisfies a predefined policy that is based on the environmental attributes. In response to determining that the ABE token satisfies the predefined policy, the ABE token is authenticated. In response to authenticating the ABE token, an action is performed using the token.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 depicts a system for enabling creation of ABE authorization codes and/or ABE tokens, in accordance with one embodiment of the present invention.

FIG. 4 depicts a system for using ABE authorization codes, in accordance with one embodiment.

FIG. 5 is a flowchart of a method, in accordance with one embodiment of the present invention.

FIG. 6 depicts a system for using ABE tokens, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for using ABE as a mechanism of encoding attributes required for ensuring an access policy or constraint is satisfied within a token and/or an authorization code.

In one general embodiment, a computer-implemented method includes receiving, by a token service, an Attribute Based Encryption (ABE) authorization code having environmental attributes encoded therein. At least one test is performed, by the token service, on the ABE authorization code using ABE decryption for determining whether the ABE authorization code satisfies a predefined policy that is based on the environmental attributes. In response to determining that the ABE authorization code satisfies the predefined policy, a token is issued by the token service.

In another general embodiment, a computer-implemented method includes receiving, by a computer, an ABE token having environmental attributes encoded therein. At least one test is performed, by the computer, on the ABE token using ABE decryption for determining whether the ABE token satisfies a predefined policy that is based on the environmental attributes. In response to determining that the ABE token satisfies the predefined policy, the ABE token is authenticated. In response to authenticating the ABE token, an action is performed using the token.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for generation and use of ABE authorization codes and/or ABE tokens in block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

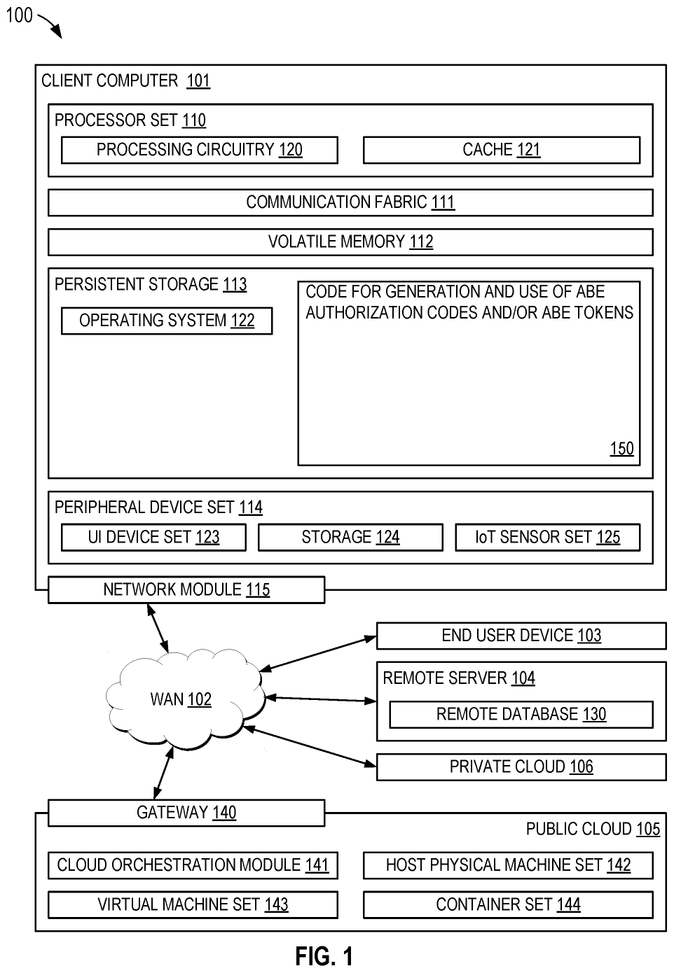

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As noted above, some types of authorization protocols such as OAuth2 allow users to authorize access to data they own on one site to third party sites for data processing use cases. Illustrative use cases range from printing photos the user stores in the cloud to running analytics against data stored in data lakes. There is no limit on the number of potential data processing use cases.

ABE is a mechanism in which keys and cipher text are dependent upon attributes.

Client applications, resource servers, service providers, etc. need a way to identify how and where tokens and authorization codes were generated within an authorization protocol such as OAuth2. For example, this may be needed to satisfy custom access policies, or perhaps regulations from a nation-state. These entities need a secure mechanism to encode, or otherwise map, information needed to ensure policies are satisfied via a well-defined mechanism that can be applied to other use cases. For example, assume an enterprise has a rule set defining which users can access which data, whether there are certain encryption policies that need to be applied, whether multi factor authentication is to be used, etc. It would be desirable to have a way to encode or describe information about the pertinent policy information or rule set in the tokens or authorization codes that are passed around in these frameworks.

The present disclosure describes a methodology that uses ABE as the mechanism of encoding attributes required for ensuring access policies or constraints in an authorization scheme are satisfied within the token or authorization code itself. Such methodology may be used to improve a particular flow in OAuth2, namely the authorization code grant flow.

The following terms are used herein.
Client application/service provider: Application requesting data access on behalf of a user or provider that relies on delegated access/authentication.
Resource server: Host that controls user resources.
Authorization code service (ACS): Entity issuing authorization codes.
Token service (TS): Entity issuing tokens.

One goal of the methodology presented herein is to modify an authorization code flow, and/or other flows in which tokens are issued, such that either or both of the authorization code and issued token(s) act as an ABE key or keys. In some embodiments, these ABE keys are constructed in a way such that the location of issuance (e.g., as determined by GPS data, subnet, IP address, data center, rack, etc.) and/or location of valid use is encoded within the key.

Thus, for example, a TS or resource server can determine location of other parties based on the ABE authorization code. Moreover, other environmental attributes regarding parties can be encoded into the ABE authorization code.

One benefit of this approach is that the cryptographic material provides proof that an OAuth2 authorization code was either issued to/from a specific environment, where the environment may be characterized by any network attribute or physical attribute.

Another benefit of this approach is that the cryptographic material provides proof a token was issued to or from a specific environment, where the environment can be defined as any network attribute or physical attribute.

In addition, these materials may provide evidence that controls are met according to regulations within governments or private enterprises.

Either or both of the known methods of ABE may be adapted for use to implement various aspects of the present invention. The two methods are key-policy attribute-based encryption (KP-ABE) and ciphertext-policy attribute-based encryption (CP-ABE).

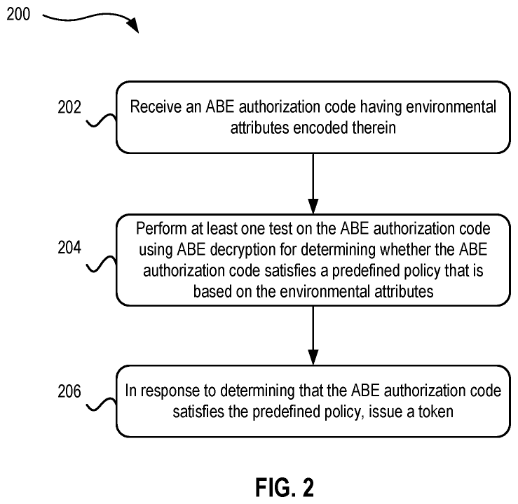

Now referring to FIG. 2, a flowchart of a method 200 is shown according to one embodiment. The method 200 may be performed in accordance with the present invention in any of the environments depicted in FIG. 1, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 2, method 200 may initiate with operation 202, in which an ABE authorization code having environmental attributes encoded therein is received by a TS. The ABE authorization code may act as an ABE key that is constructed in a way such that characteristics such as the location of issuance (e.g., as determined by GPS data, subnet, IP address, data center, rack, etc.) and/or location of valid use is encoded within the ABE key.

The ABE authorization code may be created using conventional ABE techniques adapted according to the teachings herein. For example, a conventional authorization code may be encrypted using an ABE key (e.g., a user's private key, a public key corresponding to the user's private key) to encode the environmental attributes into a resulting ABE authorization code. More information about key generation and use is provided below. In one approach, the environmental attributes may be encoded into the ABE key, and thus the ABE authorization code has the environmental attributes encoded therein by virtue of encryption using the ABE key.

In one embodiment, the ABE authorization code is in the form of an ABE key. In such aspect, performing the at least one test includes attempting to decrypt an “encrypted blob” corresponding to the policy using the ABE key. An encrypted blob may be any data object that is associated with a policy, and which can be unencrypted via ABE decryption using the ABE authorization code also corresponding to that policy.

Note that the TS may have many encrypted blobs, each blob being associated a respective policy. The ABE authorization code will only unlock a blob associated with the same policy as the ABE authorization code. Thus, a TS having blobs for many policies, upon receiving an ABE key, may attempt to sequentially decrypt each blob until a successful decryption is achieved. This may be conceptually thought of as “one key, many doors.” Upon successful decryption, the TS knows which policy the ABE authorization code pertains to, and may issue a corresponding token.

In another embodiment, the ABE authorization code is in the form of ciphertext. In such approach, performing the at least one test includes attempting to decrypt the ciphertext using an ABE key corresponding to the policy. The TS in such approach may have many ABE keys, e.g., one per policy. This may be conceptually thought of as “many keys, one door.”

An environmental attribute may be characterized as any network attribute or physical attribute. Any environmental attributes that would become apparent to unskilled in the art after reading present disclosure may be used. A nonexhaustive list of exemplary environmental attributes include attributes corresponding to: Operating System (OS), user agent, Global Positioning System (GPS) coordinates, time and/or date, encryption algorithm availability, browser information, subnet information, and Federal Information Processing Standards (FIPS) compliance information.

In some embodiments, the environmental attributes identify where and/or how the ABE authorization code was generated.

In other embodiments, the environmental attributes identify where the ABE authorization code is issued to, e.g., to verify that the destination of the ABE authorization code is proper.

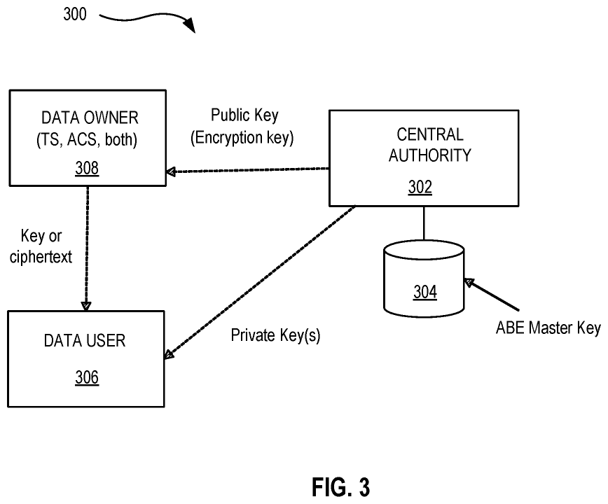

FIG. 3 depicts a system 300 for enabling creation of ABE authorization codes and/or ABE tokens, in accordance with one embodiment. As an option, the present system, 300 may be implemented in conjunction with features from any other embodiment listed herein, such as those described with reference to the other FIGS. Of course, however, such system 300 and others presented herein may be used in various applications and/or in permutations which may or may not be specifically described in the illustrative embodiments listed herein. Further, the system 300 presented herein may be used in any desired environment.

ABE allows for encoding of attributes (defined by policies) within the key and resulting ciphertext.

As shown in FIG. 3, a central authority 302 may provide key(s), such as a public key (encryption key) and a private key pair created using a master key 304. When using ABE encryption, the same master key 304 may be used to create multiple pairs of keys, where each pair of keys is generated based on a unique set of attributes. Those attributes are then encoded into the public key and the private key. The private key is typically provided to the user 306. The public key may be provided to the TS, ACS, or both (collectively shown as a Data Owner 308 in FIG. 3).

Thus, the central authority 302 provisions the pertinent content, and then distributes the key pair to parties that satisfy those attributes. One party can be sure that the other party has the proper attributes, and vice versa, because, when an item is encrypted using the public key, and then a recipient of the encrypted item wants to decrypt that item, the private key held by the recipient has the necessary attributes to perform the decryption. Likewise, the private key holder who is doing the decryption can be sure that the possessor of the public key who encrypted the item had the public key to encrypt the item.

As noted above, the ACS creates codes for the authorization code grant flow, while the TS mints tokens. The ACS and TS can be separate services or a single service serving dual functions.

Consider the illustrative case where an OAuth2 Authorization Server (AS) are sufficiently de-composed into separate services, including a TS and an ACS. Either the TS or ACS (or both) can act as the trusted authority of ABE and provision keys with the master key 304. The TS and ACS can also operate independently. Note a level of trust may be established between the TS, ACS, and relying party (e.g., a client application).

In alternate embodiments, the TS, ACS, (or both), or a 3rd party (not shown) can act as the ABE central authority.

Referring again to FIG. 2, in operation 204, at least one test is performed on the ABE authorization code using ABE decryption for determining whether the ABE authorization code satisfies a predefined policy that is based on environmental attributes.

Known ABE decryption techniques may be used to extract the environmental attributes from the ABE authorization code.

The policy may specify, for example, which environmental attributes must be in the ABE authorization code in order for the ABE authorization code, or underlying authorization code, to allow further processing and/or use of the authorization code, e.g., to allow exchange of the authorization code for a token.

Note that other attributes may be required for successful decryption and/or authorization, such as user agent, OS or platform identification, availability of certain encryption algorithms, and/or time of day/date.

In operation 206, in response to determining that the ABE authorization code satisfies the predefined policy, the TS issues a token.

In some embodiments, the token that is issued is a conventional token.

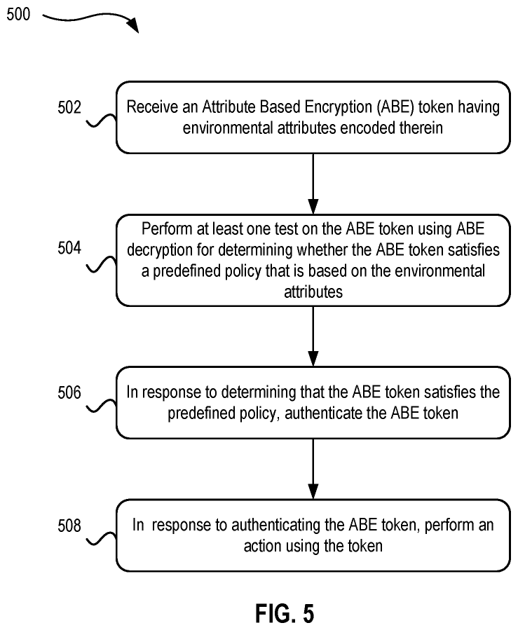

In other embodiments, the token that is issued is an ABE token having second environmental attributes encoded therein. Such second environmental attributes may be any type of environmental attributes, e.g., similar to those described elsewhere herein. For example, the second environmental attributes may correspond to the TS; a destination of the ABE token, e.g., the client or relying party that will receive the issued ABE token; etc. See, e.g., FIG. 5 and related description for exemplary use of an ABE token.

In OAuth2, tokens are issued, for example, to client applications that represent an access grant or authentication event.

In an illustrative embodiment, the ACS can provision ABE keys, and thus, the ACS can also choose to issue authorization codes that are the ABE keys. These are known as ABE authorization codes. The TS may be provisioned with a set of valid locations as encrypted blobs for both ACS and OAuth2 Relying Parties. The ACS may be configured to issue an ABE authorization code with both location attributes of itself (e.g., based on public IP address or some other metadata like GPS data) and location attributes of the relying party (e.g., based on public IP address or some other metadata like GPS data). The TS, when it receives an ABE code is in turn able to test each set of blobs to validate the code was issued by the ACS and to the Relying Party without any additional introspection of the network. One benefit of this approach is that the TS is then able to handle codes from one or more ACS instances (thereby enabling an increase in scale) and the authorization code itself is able to act as proof it was issued by one of the valid and trusted ACS instances.

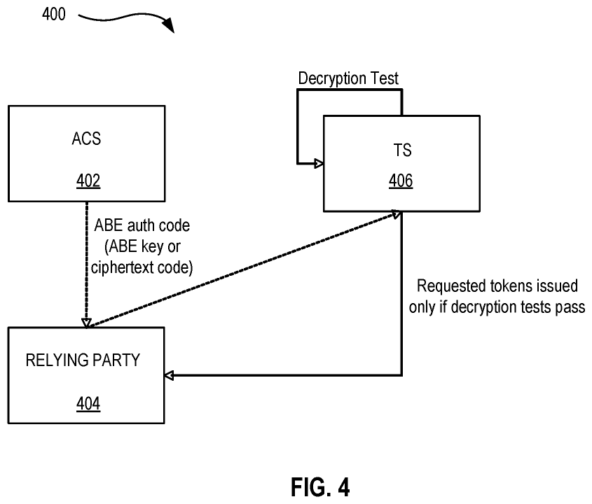

FIG. 4 depicts a system 400 for using ABE authorization codes, in accordance with one embodiment. As an option, the present system, 400 may be implemented in conjunction with features from any other embodiment listed herein, such as those described with reference to the other FIGS. Of course, however, such system 400 and others presented herein may be used in various applications and/or in permutations which may or may not be specifically described in the illustrative embodiments listed herein. Further, the system 400 presented herein may be used in any desired environment.

In the exemplary system 400 shown, an ACS 402 sends an ABE authorization code, which may be in the form of an ABE key or ciphertext to a relying party 404. The relying party 404 sends the ABE authorization code to the TS 406 with a request for a token. The TS 406 performs the aforementioned test on the ABE authorization code using ABE decryption. If the ABE authorization code passes the decryption tests, a token is issued and returned to the relying party.

Authorization code formats may be defined by the ACS. In this illustrative ABE scheme, the authorization code can be an ABE key or ciphertext. Required metadata attributes describing ACS are encoded with key/ciphertext.

The TS contains a policy for any set of environmental attributes/rules that must be satisfied before exchanging the authorization code for a token (e.g., IP address range, user-agent, time of day, etc.). For example, the TS may store one encrypted blob per policy if the authorization code is ABE key (one key, many doors), for many policies. Moreover, if the authorization code is cyphertext, the TS may store one decryption key per policy (one door, many keys), for many policies.

Note that the authorization code, because it is passed from the ACS to the relying party to the TS, may also contain metadata of the relying party. Moreover, the token may also have such attributes (or a different set) embedded therein.

The TS 406 performs the aforementioned decryption test on the ABE authorization code using ABE decryption for each policy. If code is an ABE key, it is tested against each encrypted blob. If the authorization code is ciphertext, it is tested against each key. If the authorization code passes a test, the TS, via ABE, has cryptographically verified metadata about other parties involved in the token exchange. This in turn reduces difficulty of one TS having many ACS (or vice versa) because the policy if self-contained in code.

Now referring to FIG. 5, a flowchart of a method 500 is shown according to one embodiment. The method 500 may be performed in accordance with the present invention in any of the environments depicted in FIGS. 1-4, among others, in various embodiments. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 may initiate with operation 502, where an ABE token having environmental attributes encoded therein is received. The environmental attributes may be as described elsewhere herein. For example, in one embodiment, the environmental attributes identify where and/or how the ABE token was generated. In another embodiment, the environmental attributes encoded in the ABE token correspond to environmental attributes of the token service that issued the ABE token. In yet another embodiment, the environmental attributes encoded in the ABE token correspond to a destination of the ABE token, e.g., the location or other characteristic of an entity that will receive and use the ABE token for some purpose such as the client or relying party that will receive the issued ABE token.

In operation 504, at least one test is performed on the ABE token using ABE decryption. Decryption tests similar to those listed above in the method 200 for using ABE authorization codes may be used in operation 504 to test the ABE token. The test determines whether the ABE token satisfies a predefined policy that is based on the environmental attributes. The predefined policy may be similar to, and/or have a similar purpose as, other predefined policies listed herein, but for use with the ABE token.

In operation 506, in response to determining that the ABE token meets the predefined policy, the ABE token is authenticated.

In operation 508, in response to authenticating the ABE token, an action is performed using the token. Any action that would become apparent to one skilled in the art after reading the present disclosure may be performed. For example, if the relying party is the entity authenticating the ABE token, the relying party may forward the ABE token to a resource server to access the desired data. Likewise, if a resource server is the entity authenticating the ABE token, the resource server may grant the access requested in conjunction with the ABE token if the ABE token is deemed to be authentic.

In one embodiment, the action includes forwarding the ABE token to a resource server with a request to access desired data from the resource server. In another embodiment, the action includes providing, by a resource server, access to desired data.

In one exemplary embodiment, consider the case where the TS is capable of provisioning ABE keys. The TS can choose to issue opaque access tokens that are also ABE Keys. The ABE access tokens may contain the encoded location of the intended audiences (e.g., relying party or resource server(s)). For example, when a resource server receives an OAuth2 ABE access token, it could test a set of encrypted blobs that represent its expected relying parties and/or itself.

In yet another aspect of the present invention, it is possible to issue an authorization code that is also ABE cipher text. In this approach, the TS and/or resource server are preferably provisioned with a set of valid ABE keys for the tests, e.g., the tests performed in operations 204 and 504 above. See FIGS. 2 and 5. The overall mechanics of this aspect are essentially the same as those described above.

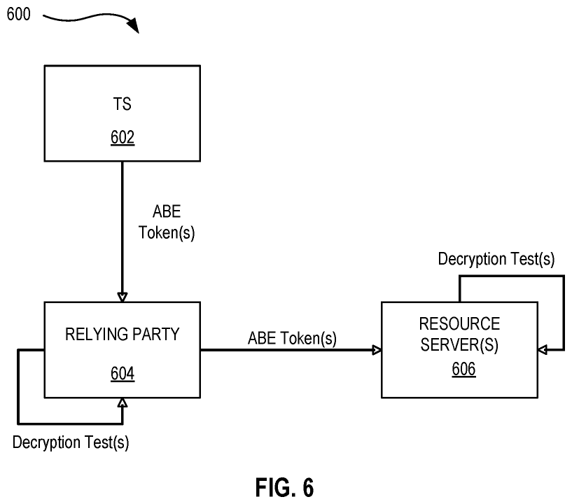

FIG. 6 depicts a system 600 for using ABE tokens, in accordance with one embodiment. As an option, the present system, 600 may be implemented in conjunction with features from any other embodiment listed herein, such as those described with reference to the other FIGS. Of course, however, such system 600 and others presented herein may be used in various applications and/or in permutations which may or may not be specifically described in the illustrative embodiments listed herein. Further, the system 600 presented herein may be used in any desired environment.

In the exemplary system 600 shown, a TS 602 sends an ABE token, which may be in the form of an ABE key or ciphertext, to a relying party 604. The relying party 404 may perform encryption test on the ABE token, e.g., in a manner similar to the testing described elsewhere herein for ABE authorization codes and ABE tokens. Preferably, if the ABE token passes the test at the relying party, the relying party may send the ABE token to a resource server 606 with a request for the desired resource. The resource server 606 may also perform decryption tests on the ABE token. If the ABE token passes a test at the resource server 606, the requested resource is made available.

In other approaches, the relying party may simply pass the ABE token on to the resource server, e.g., only the resource server performs the decryption testing. In further approaches, the relying party performs the decryption testing on the ABE token and the resource server does not perform decryption testing.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a token service, an Attribute Based Encryption (ABE) authorization code having environmental attributes encoded therein;
performing, by the token service, at least one test on the ABE authorization code using ABE decryption for determining whether the ABE authorization code satisfies a predefined policy that is based on the environmental attributes; and
in response to determining that the ABE authorization code satisfies the predefined policy, issuing, by the token service, a token.

2. The computer-implemented method of claim 1, wherein at least one of the environmental attributes is selected from a group consisting of: Operating System (OS), user agent, Global Positioning System (GPS) coordinates, time and/or date, encryption algorithm availability, browser information, subnet information, and Federal Information Processing Standards (FIPS) compliance information.

3. The computer-implemented method of claim 1, the ABE authorization code is in the form of an ABE key, wherein performing the at least one test includes attempting to decrypt an encrypted blob corresponding to the policy using the ABE key.

4. The computer-implemented method of claim 1, the ABE authorization code is in the form of ciphertext, wherein performing the at least one test includes attempting to decrypt the ciphertext using an ABE key corresponding to the policy.

5. The computer-implemented method of claim 1, wherein the environmental attributes identify where and/or how the ABE authorization code was generated.

6. The computer-implemented method of claim 1, wherein the environmental attributes identify where the ABE authorization code was issued to.

7. The computer-implemented method of claim 1, wherein the token is an ABE token having second environmental attributes encoded therein, the second environmental attributes corresponding to the token service.

8. The computer-implemented method of claim 1, wherein the token is an ABE token having second environmental attributes encoded therein, the second environmental attributes corresponding to a destination of the ABE token.

9. The computer-implemented method of claim 1, comprising:
receiving, by a second computer, the token, wherein the token is an ABE token having second environmental attributes encoded therein;
performing, by the second computer, at least one test on the ABE token using ABE decryption for determining whether the ABE token satisfies a second predefined policy that is based on the second environmental attributes;
in response to determining that the ABE token satisfies the second predefined policy, authenticating the ABE token; and
in response to authenticating the ABE token, performing an action using the token.

10. A computer program product, the computer program product comprising:
one or more computer readable storage media, and program instructions collectively stored on the one or more computer readable storage media, the program instructions comprising program instructions to perform the method of claim 1.

11. A system, comprising:
a processor; and
logic integrated with the processor, executable by the processor, or integrated with and executable by the processor, the logic being configured to perform the method of claim 1.

12. A computer-implemented method, comprising:
receiving, by a computer, an Attribute Based Encryption (ABE) token having environmental attributes encoded therein;
performing, by the computer, at least one test on the ABE token using ABE decryption for determining whether the ABE token satisfies a predefined policy that is based on the environmental attributes;
in response to determining that the ABE token satisfies the predefined policy, authenticating the ABE token; and
in response to authenticating the ABE token, performing an action using the token.

13. The computer-implemented method of claim 12, wherein at least one of the environmental attributes is selected from a group consisting of: Operating System (OS), user agent, Global Positioning System (GPS) coordinates, time and/or date, encryption algorithm availability, browser information, subnet information, and Federal Information Processing Standards (FIPS) compliance information.

14. The computer-implemented method of claim 12, wherein the action includes forwarding the ABE token to a resource server with a request to access desired data from the resource server.

15. The computer-implemented method of claim 12, wherein the action includes providing, by a resource server, access to desired data.

16. The computer-implemented method of claim 12, wherein the environmental attributes identify where and/or how the ABE token was generated.

17. The computer-implemented method of claim 12, wherein the environmental attributes encoded in the ABE token correspond to environmental attributes of a token service that issued the ABE token.

18. The computer-implemented method of claim 12, wherein the environmental attributes encoded in the ABE token correspond to a destination of the ABE token.

19. A computer program product, the computer program product comprising:
one or more computer readable storage media, and program instructions collectively stored on the one or more computer readable storage media, the program instructions comprising program instructions to perform the method of claim 12.

20. A system, comprising:
a processor; and
logic integrated with the processor, executable by the processor, or integrated with and executable by the processor, the logic being configured to perform the method of claim 12.
